(19) United States
(12) Patent Application Publication
(10) Pub. No.: US 2011/0261075 A1
(43) Pub. Date: Oct. 27, 2011

(54) ELECTRONIC IMAGE VIEWING DEVICE

(75) Inventor: Masahide Tanaka, Osaka (JP)

(73) Assignee: ROHM CO., LTD., Kyoto (JP)

(21) Appl. No.: 13/142,130

(22) PCT Filed: Dec. 24, 2009
(86) PCT No.: PCT/JP2009/071411

§ 371 Date: Jun. 24, 2011

(30) Foreign Application Priority Data
Dec. 26, 2008 (JP) 2008-332260

(51) Int. Cl. G09G 5/02; G09G 5/00

(52) U.S. Cl. 345/649; 345/204; 345/698

(57) ABSTRACT

A common image of a clock or the like is always displayed in a space that is not covered by a horizontally long image or a vertically long image. Positions of corners of the images on the side diagonally opposite the common image are made to match. When a switch is made between a horizontally long image and a vertically long image, an animation effect is added to alleviate any feeling of strangeness. Image comments displayed for the vertically long image are divided and distributed appropriately in the space. Either a horizontally long image or a vertically long image is displayed in the center of a display screen that is vertically and horizontally isotropic and assumes the shape of a square rotated 45 degrees or a circle. An ordinary display device is tilted 45 degrees to form a square display screen that is rotated 45 degrees. Electronic paper is used, and slow rewriting speed is addressed by rewriting the image during nighttime sleeping hours. The speed at which monochrome images are rewritten is matched with that of color images to alleviate any feeling of strangeness when the monochrome and color images are combined.

### TECHNICAL FIELD

The present invention relates to an electronic image viewing device.

### BACKGROUND ART

Over the past several years, electronic picture frames for viewing digital images have been proposed and have come into general use. Since picture images are rectangular and are photographed in horizontally long format such as landscape format or vertically long format such as portrait format depending on the photographed subject, various types of displays have been proposed over the years. For example, there has been proposed an electronic picture frame designed such that horizontally long images or vertically long images can be displayed in a square display screen. Also proposed have been digital cameras and the like designed such that information of the captured image is displayed in the margin regions that form when a horizontally long image or a vertically long image is displayed in a square display screen.

### LIST OF CITATIONS

### Patent Literature

Patent Literature 1: Japanese Laid-open Patent Application No. 2007-135156
Patent Literature 2: Japanese Laid-open Patent Application No. 2008-236395

### SUMMARY OF INVENTION

### Technical Problem

However, there are various problems to be considered in order to display horizontally long images and vertically long images.

In view of the foregoing, it is an object of the present invention to provide an electronic image viewing device whereby horizontally long images and vertically long images can be displayed in a pleasing manner.

### Solution to Problem

To achieve the object described above, the electronic image viewing device of one aspect (a first aspect) disclosed in the Specification a display screen capable of displaying both a horizontally long image and a vertically long image, and a display controller for displaying either a horizontally long image or a vertically long image on the display screen and always displaying a common image in an empty space not covered by the horizontally long image or the vertically long image when either the horizontally long image or the vertically long image is displayed.

The electronic image viewing device according to the first aspect described above may be an electronic image viewing device of another aspect (second aspect) in which the display screen is held in place so as to be incapable of rotating in the plane thereof; and, when a vertically long image is to be displayed, the controller displays the image rotated 90 degrees in a relative manner, without trimming or changing the size of the image.

The electronic image viewing device according to the first aspect described above may be an electronic image viewing device of another aspect (third aspect) in which the display controller performs a control so that a position where one corner of the horizontally long image and that of the vertically long image are displayed matches.

The electronic image viewing device according to the third aspect described above may be an electronic image viewing device of another aspect (fourth aspect) in which the display controller causes the positions of the corners of the images to match on a side diagonally opposite a position where the common image is displayed.

The electronic image viewing device according to the first aspect described above may be an electronic image viewing device of another aspect (fifth aspect) in which the display controller causes an image switching mode to differ between a case in which switching between a horizontally long image and a vertically long image is made, and a case in which switching between two horizontally long images or between two vertically long images is made.

The electronic image viewing device according to the first aspect described above may be an electronic image viewing device of another aspect (sixth aspect) in which the common image is time information.

The electronic image viewing device according to the first aspect described above may be an electronic image viewing device of another aspect (seventh aspect) in which the display controller also displays an image comment on the display screen and divides the display of the image comment when a vertically long image is to be displayed.

An electronic image viewing device according to another aspect (eighth aspect) as disclosed in the present specification comprises a display screen, which is capable of displaying both a horizontally long image and a vertically long image, and which is vertically and horizontally isotropic, wherein an edge of the display screen facing a side of the displayed image is not parallel to the side of the image; and a display controller for causing either a horizontally long image or a vertically long image to be displayed in a center of the display screen.

The electronic image viewing device according to the eighth aspect described above may be an electronic image viewing device of another aspect (ninth aspect) in which the display screen is held in place so as to be incapable of rotating in the plane thereof; and, when a vertically long image is to be displayed, the controller displays the image rotated 90 degrees in a relative manner, without trimming or changing the size of the image.

The electronic image viewing device according to the eighth aspect described above may be an electronic image viewing device of another aspect (tenth aspect) in which the display controller also displays an image comment on the display screen and divides the display of the image comment when a vertically long image is to be displayed.

The electronic image viewing device according to the tenth aspect described above may be an electronic image viewing device of another aspect (eleventh aspect) in which the display controller displays the divided image comments so that the comments are arranged on both the left and right sides of the vertically long image.

The electronic image viewing device according to the eighth aspect described above may be an electronic image viewing device of another aspect (twelfth aspect) in which the display screen is substantially square-shaped and is tilted at a 45 degree angle in relation to the horizontal direction.

The electronic image viewing device according to the eighth aspect described above may be an electronic image viewing device of another aspect (thirteenth aspect) in which the display screen has a display device disposed at an incline relative to the horizontal direction, and the display controller causes either a horizontally long image or a vertically long image to be displayed on the display device, wherein the horizontally long image and the vertically long image are rotated at respectively different angles.

The electronic image viewing device according to the thirteenth aspect described above may be an electronic image viewing device of another aspect (fourteenth aspect) in which the display device is disposed at a 45 degree tilt in relation to the horizontal direction, and the display controller displays either a horizontally long image or a vertically long image at different angles of rotation so that a vertical direction of each of the images is upright.

The electronic image viewing device according to the eighth aspect described above may be an electronic image viewing device of another aspect (fifteenth aspect) in which the display screen has electronic paper, and the electronic image viewing device comprises a unit for rewriting an image displayed on the display screen, and a display controller for controlling the rewriting performed by the rewriting unit on the basis of a predetermined condition.

An electronic image viewing device according to another aspect (sixteenth aspect) as disclosed in the present specification preferably comprising a display screen having electronic paper, a unit for rewriting an image displayed on the display screen, and a display controller for controlling the rewriting performed by the rewriting unit on the basis of a predetermined condition.

The electronic image viewing device according to the sixteenth aspect described above may be an electronic image viewing device of another aspect (seventeenth aspect) in which the display controller detects a timing at which the display screen is not viewed, and performs rewriting using the detected timing as a condition.

The electronic image viewing device according to the seventeenth aspect described above may be an electronic image viewing device of another aspect (eighteenth aspect) in which the display controller detects a timeframe before dawn.

The electronic image viewing device according to the sixteenth aspect described above may be an electronic image viewing device of another aspect (nineteenth aspect) comprising a detector for detecting whether the image displayed on the display screen is in color or monochrome, wherein the display controller performs rewriting using a detection result of the detector as a condition.

The electronic image viewing device according to the nineteenth aspect described above may be an electronic image viewing device of another aspect (twentieth aspect) wherein, when the detector has detected that the image is in monochrome, the display controller performs a control so that a speed at which the image is rewritten is caused to match a speed at which a color image is rewritten.

### Advantageous Effects of the Invention

According to the present invention, horizontally long images and vertically long images can be displayed in a pleasing manner.

### BRIEF DESCRIPTION OF DRAWINGS

FIG. 1 A block diagram showing a first example of an electronic picture frame according to an embodiment of the present invention

FIG. 2 Front views of screens showing the display contents of display images of the first example

FIG. 3 A flowchart showing the functions of the controller in the first example

FIG. 4 A flowchart showing the details of step S24 of FIG. 3

FIG. 5 An external front view showing a second example of the electronic picture frame according to the embodiment of the present invention

FIG. 6 Front views of screens showing the display contents of the display screen 104 of the second example

FIG. 7 A flowchart showing the functions of the controller in the second example

FIG. 8 An external front view showing a third example of the electronic picture frame according to the embodiment of the present invention

### DESCRIPTION OF EMBODIMENTS

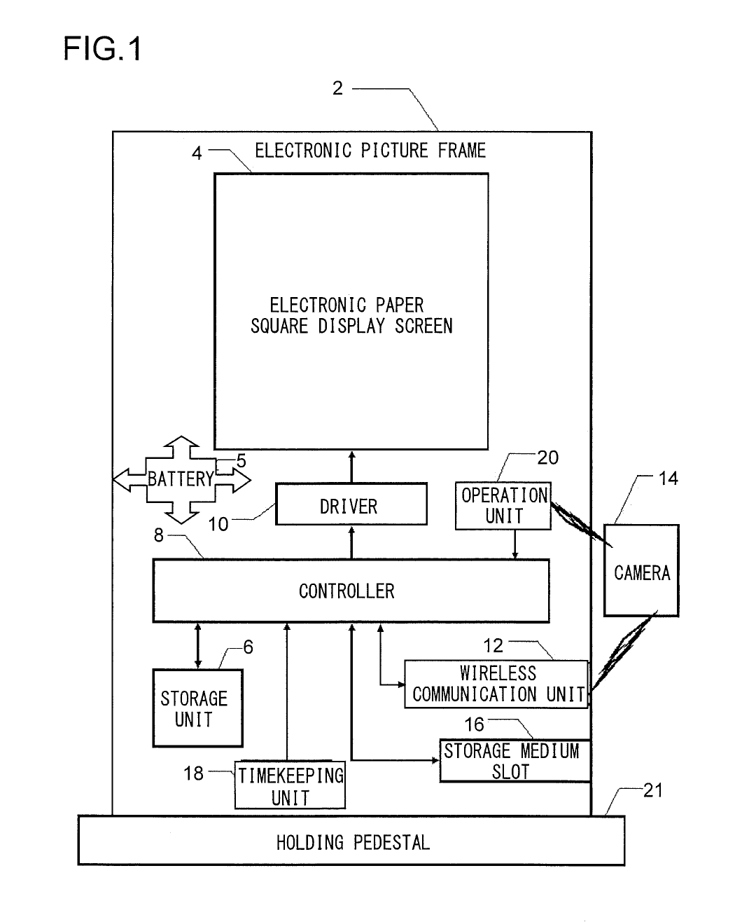

FIG. 1 is a block diagram showing a first example of an electronic picture frame according to an embodiment of the present invention. An electronic picture frame 2 has a display screen 4 composed of square electronic paper, and image data stored in a storage unit 6 or the like is displayed by the control of a controller 8. The storage unit 6 stores image data, and also stores programs needed for the functions of the controller 8 and temporary data needed for control. The controller 8 reads image data from the storage unit 6 in accordance with programs in the storage unit 6 and rewrites images displayed on the display screen 4 by a driver 10. Since the display screen 4 is composed of electronic paper, images are preserved and remain displayed even when the power supply is cut off after image rewriting. The electronic picture frame 2 can thereby display image data for a long period of time by the power source driving of a battery 5.

The image data stored in the storage unit 6 is received from a camera 14 or the like through a wireless communication unit 12 which uses a wireless LAN, a Bluetooth™ connection, or another scheme. The wireless communication unit 12 is also capable of receiving image data from a cellular telephone. The controller 8 can also display image data stored in an external storage medium inserted into a storage medium slot 16. The image data outputted from the storage medium slot 16 can also be read from the storage unit 6 after being incorporated into the storage unit 6.

A timekeeping unit 18 provides time data for a clock displayed on the display screen 4 and also functions as a timer for determining the timing for rewriting the image displayed on the display screen 4. The image can be rewritten automatically according to a timer, or at any desired timing via the operating of an operation unit 20. The operation unit 20 includes a manual operation switch provided to the electronic picture frame 2, and an infrared light receiver for receiving the operating of the remote control. This infrared light receiver is capable of receiving operation signals from the camera 14, in which case the electronic picture frame 2 serves as a large-screen image viewing device for displaying the images of the camera 14 on the display screen 4 by the operation of the camera 14.

The electronic picture frame 2 is held securely in place on a holding pedestal 21 and is configured so that its orientation cannot be changed vertically or horizontally. The image data has a combination of horizontally long and vertically long images, but since the display screen 4 has a square shape whose edges are long enough to cover the longitudinal direction of the image, both horizontally long images and vertically long images can be displayed on the entire screen without rotating the electronic picture frame 2 or the display screen 4 or without changing or trimming the size of the display image. However, the display screen 4 also has empty space where the image is not displayed in the short direction of the image. The present invention performs a control so that there is no feeling of strangeness due to such empty space or switching between horizontally long images and vertically long images.

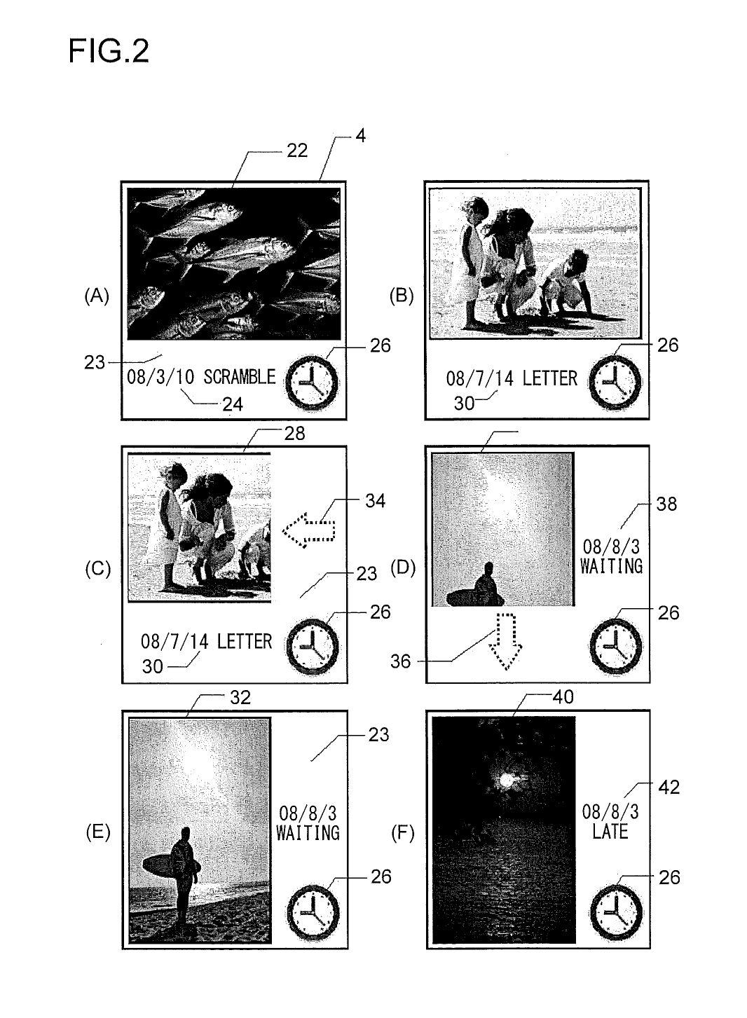

FIG. 2 consists of front views of screens showing the display contents of the display screen 4 of FIG. 1, and provides a detailed depiction of the manner of controlling a feeling of strangeness due to the presence of empty space in which on photographic images are displayed, or to switching between horizontally long images and vertically long images. In FIG. 2(A), a horizontally long image 22 is displayed on the display screen 4, and the date of capture, title, and other comments 24 associated with the photographed image are displayed along with a clock 26 in the empty space 23. Regardless of whether the photographic image is in a horizontally or vertically long format, the clock 26 is provided in the empty space not covered by the image. In other words, a sense of unity and consistency is created in the display screen 4 by having the clock 26 always displayed in the same position unrelated to the switching between horizontally long images and vertically long images. It is also desirable to provide an appropriate wallpaper design in the background portion of the empty space 23, whereby the resulting presentation preserves a sense of ordered unity over the entire display screen 4.

FIG. 2(B) shows the display contents of the display screen 4 having been rewritten from the horizontally long image 22 to the horizontally long image 28 and the image comments 30. Rewriting is performed so that the image 22 fades out and the image 28 fades in. The display of the clock 26 does not change. As is clear from comparing FIGS. 2(A) and 2(B), the overall layout does not change when the two horizontally long images are rewritten.

FIGS. 2(C) and (D) show how rewriting is performed when a vertically long image 32 is next displayed. First, the horizontally long image 28 is progressively erased from the right end toward the left as shown by arrow 34 in FIG. 2(C). At the same time, the horizontally long image 28 begins to fade out. Meanwhile, the vertically long image 32 begins to fade in; however, as shown in FIG. 2(D), the bottom end is at first not displayed, but proceeds to be progressively displayed toward the bottom end through an animation effect as shown by the arrow 36.

Of particular note is that, even during rewriting between a horizontally long image and a vertically long image, the images are laid out so that the upper left corners thereof match, and the layout of the portion common to the two images does not change, as is clear from comparing FIGS. 2(C) and 2(D). This allows for image uniformity and reduces any feeling of strangeness during switching between a horizontally long image and vertically long image. The image comments 38 are displayed after the right edge of the horizontally long image 28 has been completely erased. The image comments 30 of the horizontally long image 28 are also erased at this time.

By having the date and the title separated into different lines, the image comments 38 of the vertically long image 32 can be displayed in a narrow space while still being written horizontally and maintaining image uniformity. FIG. 2(E) shows a state in which the vertically long image 32 has been completely rewritten as described above. During this time, the display of the clock 26 does not change, as shown in FIGS. 2(B) through 2(E). The empty space 23 appearing in the state shown in FIG. 2(E) has a background integrated with the same wallpaper design as the empty space 23 of FIG. 2(A), maintaining an image having a similarity in its display screen. The harmony of the empty space 23 is prominent when the empty space 23 temporarily appears at the same time in both the right and bottom sides of the display screen 4 as shown in FIGS. 2(C) and 2(D). Together with the display of the clock 26, this alleviates any feeling of strangeness during a switch between a horizontally long image and a vertically long image.

In FIG. 2(F), the display contents of the display screen 4 have been rewritten from the vertically long image 32 to a vertically long image 40 and image comments 42. This rewriting is done so that the image 32 fades out and the image 40 fades in. The display of the clock 26 does not change here either. As is clear from comparing FIGS. 2(E) and 2(F), there is no change to the overall layout even during rewriting between two vertically long images. The manner in which a vertically long image is rewritten to a horizontally long image can be understood by starting from FIG. 2(E) and following the transitions back to FIG. 2(B). It is understood that, in such circumstances, the orientations of the arrows 36 and 34 would be turned in the opposite direction.

The position where the clock 26 is provided is not limited to being in the bottom right; it could also be the top right, the top left, or the bottom left. The position where the image is displayed will vary accordingly, as shall be apparent. For example, if the clock 26 is provided in the top left, vertically long images are displayed near the right end of the display screen 4 and horizontally long images are displayed near the bottom end. At this time, the bottom right corners of the images are made to match. Whether the display image is in a horizontally or vertically long format, the clock 26 need not be the only the item always displayed in the empty space not covered by the photographic image; the item may be the date, a calendar for the given month, or other time information; a flower, animal, or something else unrelated to the time information; or any other design. Preferably, displaying these items at the same time will not weaken the impression made by the photographic image and will maintain a clear impression of an image that is always displayed.

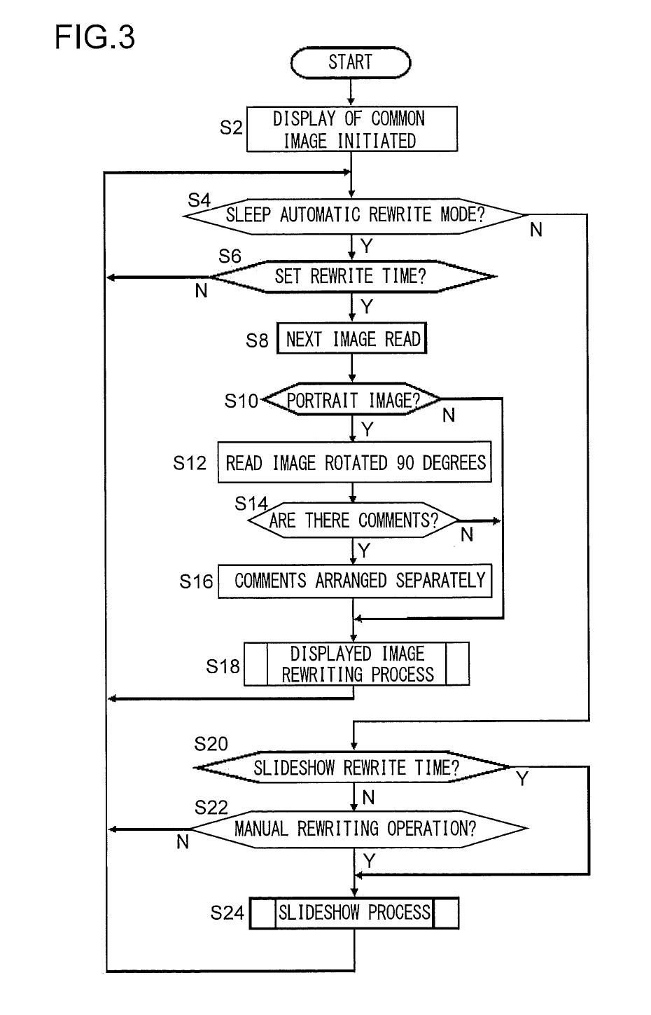

FIG. 3 is a flowchart showing the functions of the controller 8 in the first example of FIG. 1. The flow starts with the installation of the battery 5 in the electronic picture frame 2, and the functions continue thereafter as long as power continues to be supplied from the battery 5. When the flow starts, the display of a common image, i.e. the clock 26, is initiated in step S2 and is continued hereinafter. Next, in step S4, a check is made of whether or not sleep-time automatic rewrite mode is set. The term “sleep-time automatic rewrite mode” refers to a mode occurring once per day, in which the photographic images are automatically rewritten during a sleeping timeframe, such as before dawn. This mode is useful in cases in which electronic paper or, in particular, color electronic paper is used, wherein the rewriting speed performance is insufficient; and while there is no change in the photographic image before bedtime, rewriting of the photographic image is complete by the following morning when seen by someone.

When sleep-time automatic rewrite mode has been set in step S4, the process advances to step S6, and a check is made on whether or not the set rewrite time (e.g. 2:00 am) has passed. If it is detected that the rewrite time has been reached, the process advances to step S8. However, if it is detected in step S6 that the rewrite time has not yet been reached, the process returns to step S4. Thereafter, steps S4 and S6 are repeated as long as it has been detected in step S4 that the sleep-time automatic rewrite mode has been canceled, or it has not been detected in step S6 that the rewrite time has been reached.

In step S8, the next image is read from the storage unit 6 or the storage medium in the storage medium slot 16. A check of whether or not the image is a vertically long image, according to the header of the image data file that is read is then performed in the next step S10. When the image is a vertically long image, the process advances to step S12, and a process is performed for rotating the read image 90 degrees. This is performed in order to display the vertically long image vertically, as in FIG. 2(E). A check is then made in step S14 for the presence of image comments, and if there are comments, the process advances to step S16 and a process is performed for separating the image comments. The process is performed to separate the image comments 38 and display them on different lines as in FIG. 2(D). Once this process has occurred, the flow advances to step S18. If there are no image comments in step S14, the process advances directly to step S18. When the image is not a vertically long image in step S10, the process advances directly to step S18. This means that the photographic image 22 is arranged in a horizontally long format as indicated by the image data as in FIG. 2(A) and others, and the image comments 24 are arranged continuously on a single line as indicated by the image data.

In step S18, a displayed image rewriting process is performed based on the process described above. This displayed image rewriting process includes a process of rewriting the electronic paper of the display screen 4 on the basis of a predetermined action using the image data whose layout was established in steps S8 to S16, and a process of monitoring whether or not this first process has completed. When the image is rewritten and step S18 is complete, the flow returns to step S4, whereupon steps S4 to S18 are repeated as long as it is not detected in step S4 that the sleep-time automatic rewrite mode has been canceled.

If is not detected in step S4 that the sleep-time automatic rewrite mode is in effect, slideshow mode is in effect; therefore, the flow advances to step S20, where a check is made of whether or not a slideshow rewrite time has been reached. If it is not detected that this rewrite time has been reached, the flow advances to step S22 and a check is made of whether or not the operation unit 20 has been operated manually (including by remote control). If this operation is detected, the flow moves to the slideshow process of step S24. If it is detected that the slideshow rewrite time has been reached in step S20, the flow immediately and automatically moves to the slideshow process of step S24. If a manual rewriting operation is not detected in step S22, the flow returns to step S4, and as long as a change of mode to the sleep-time automatic rewrite mode is not detected in step S4, steps S4, S20, and S22 are repeated until the slideshow rewrite time is reached or a manual operation is performed.

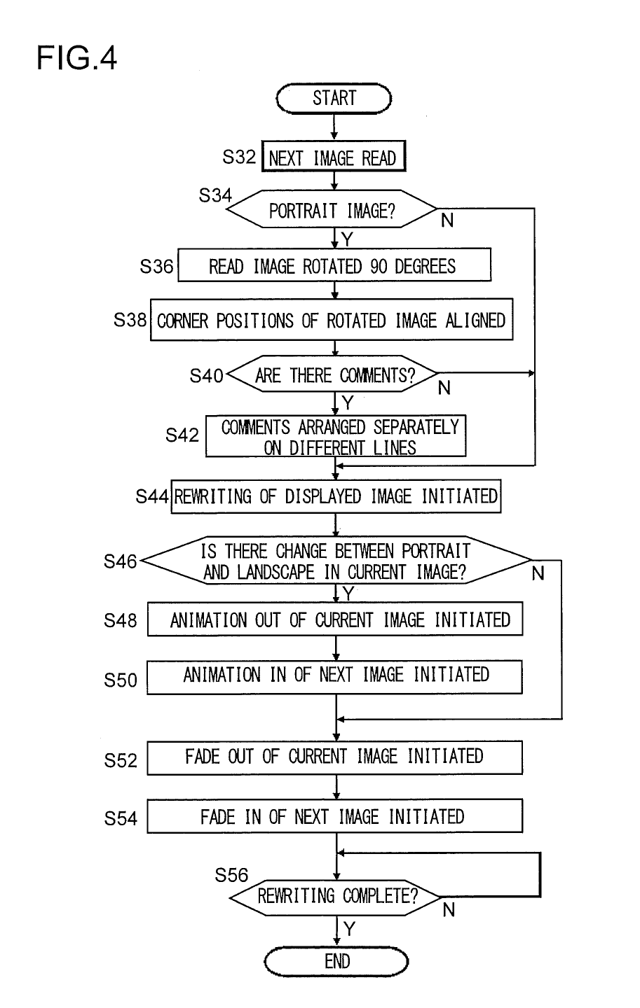

FIG. 4 is a flowchart showing the details of the slideshow process in step S24 of FIG. 3. This flow essentially corresponds to steps S8 to S18 of FIG. 3, but since the image rewriting will be seen by someone, a more elaborate process is included so that the person will experience no feeling of strangeness. When the flow starts, the next image is read from the storage unit 6 or the storage medium of the storage medium slot 16 in step S32. A check is then performed in the next step S34 in regard to whether or not the image is a vertically long image, according to the header of the read image data file. If the image is a vertically long image, the flow advances to step S36, and a process is performed for rotating the read image 90 degrees. This process is performed to display the vertically long image vertically as in FIG. 2(E). In the next step S38, the positions of the corners of the vertically long image that has been rotated are aligned. This is a process of aligning the top left corner position of the vertically long image 32 in FIG. 2(D) with the top left corner position of the horizontally long image 28, the purpose of which being to reduce any feeling of strangeness during switching between horizontally long images and vertically long images.

A check for image comments is then made in step S40, and if there are comments, the flow advances to step S42 and a process is performed for separating and arranging the image comments. This process is performed to separate the image comments 38 and display them on different lines as in FIG. 2(D). After this process takes place, the flow advances to step S44. If there are no image comments in step S40, the flow advances directly to step S44. If the image is not a vertically long image in step S34, the flow advances immediately to step S44. This means that the photographic image 22 is arranged in a horizontally long format as indicated by the image data as in FIG. 2(A), and the image comments 24 are arranged continuously on a single line as indicated by the image data.

In step S44, the displayed image rewriting is initiated based on the process described above. A check is then made in step S46 as to whether or not the image being rewritten is a change between a horizontally or vertically long image from the current image. This change includes changes from a vertically long image to a horizontally long image as well as changes from a horizontally long image to a vertically long image. When there is no change, it means that the rewriting is either from a vertically long image to another vertically long image, or from a horizontally long image to another horizontally long image. If it is detected that there is a change between a vertically long image and a horizontally long image, an animated transition away from the current image is initiated in step S48. This means that an animation action is initiated in which the horizontally long image 28 is erased progressively from the right end to the left end, as shown by the arrow 34 in FIG. 2(C), for example. An animation of the next image is also initiated in step S50. This means that an action is initiated in which the bottom end of the vertically long image 32 is at first not displayed as shown, for example, in FIG. 2(D), and the display progresses toward the bottom end due to the animation effect as shown by the arrow 36.

When the animation action as described above is initiated, the process moves to step S52. If a change between a vertically long image and a horizontally long image is not detected in step S46, the flow moves directly to step S52. In step S52, a fade out of the current image is initiated, in step S54 a fade in of the next image is initiated, and the flow reaches step S56. As described above, a fade in/out accompanying the animation is performed when there is a change between a vertically long image and a horizontally long image, and only the fade in/out is performed when there is no change between a vertically long image and a horizontally long image. These correspond to the transition from FIGS. 2(B) to 2(E) or the reverse transition, and also to the transition from FIGS. 2(A) to 2(B) or the transition from FIGS. 2(E) to 2(F). The flow then moves to step S56, monitoring is performed in regard to whether or not the rewriting is complete, and when the rewriting is detected as being complete, the flow is ended.

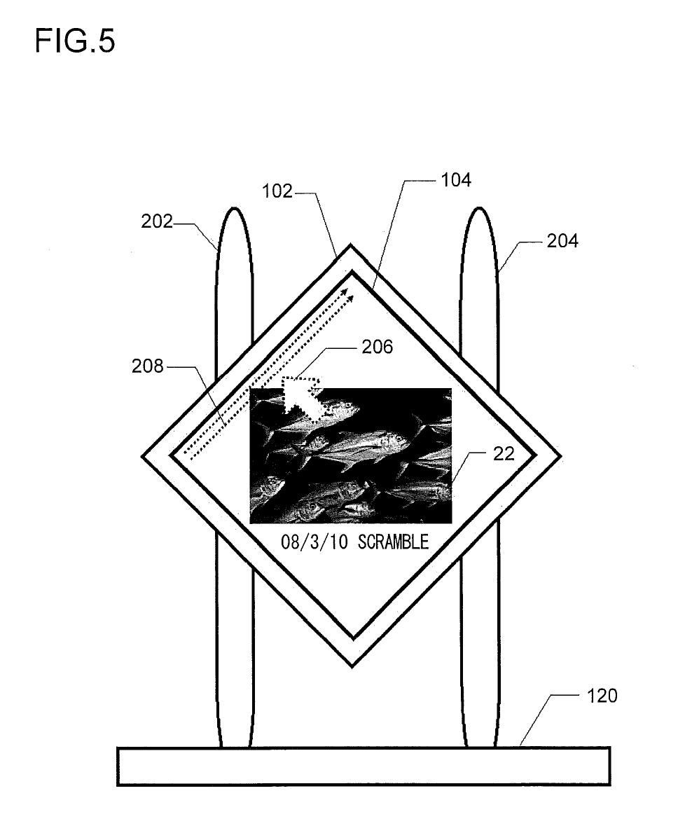

FIG. 5 is an external front view showing a second example of the electronic picture frame according to the embodiment of the present invention. An electronic picture frame 102 has a display screen 104 composed of square electronic paper tilted at a 45 degree angle, and the electronic picture frame 102 is held stationary on a holding pedestal 120 by support rods 202, 204. Therefore, in the second example as well, the configuration does not allow the orientation of the display screen 104 to be changed vertically or horizontally. Thus, except for the display screen 104 being tilted at a 45 degree angle, the second example of FIG. 5 has the same internal configuration block as the first example of FIG. 1, and the configuration block is therefore not illustrated or described.

Since the display screen 104 is tilted at a 45 degree angle as described above, the up direction for the display screen 104 as a display device is the direction of the arrow 206. Therefore, the horizontal array direction of the display elements constituting a display device is the direction of the arrows 208. Thus, the horizontally long image 22 is displayed rotated 45 degrees in relation to the display screen 104 constituting the display device, whereby the long sides thereof are displayed in a horizontal direction. Thus, if a display screen 104 is used which is vertically and horizontally isotropic and the edges facing the sides of the photographic image are not parallel with the sides of the photographic image, the photographic image is laid out in the center, thereby creating empty space in the short-side areas with a natural shape resembling that of the long-side areas, and alleviating any feeling of strangeness. As in the first example, regardless of whether the image is a vertically long image or a horizontally long image, the image can be displayed within the display screen 104 without any trimming or changes to the size of the image, merely by rotating the image in a relative manner by 90 degrees.

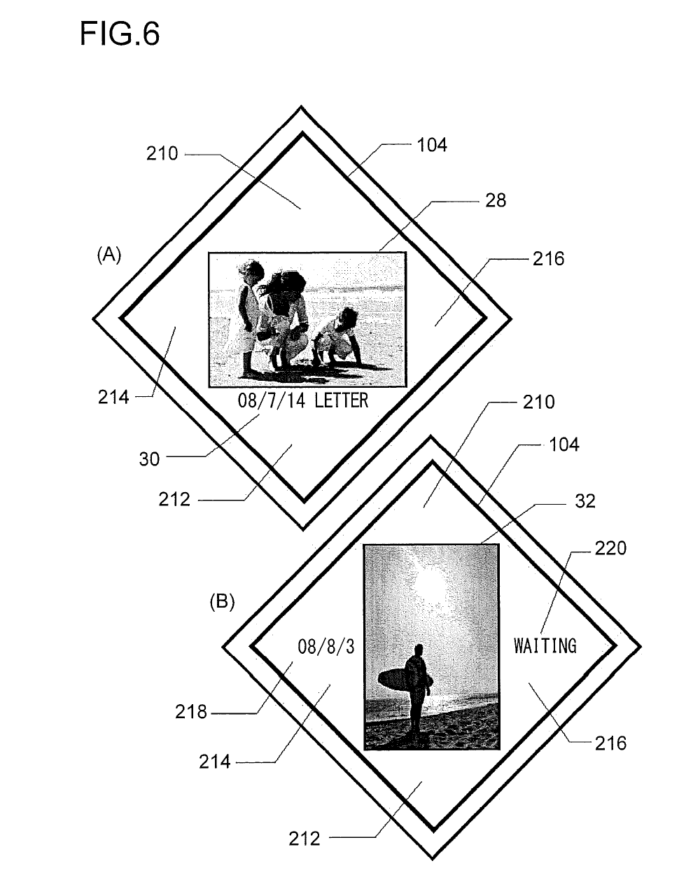

FIG. 6 represents front views of screens showing display contents of the display screen 104 of FIG. 5 as described above, the screens specifically showing that there is no feeling of strangeness associated with the presence of empty space, regardless of whether the image is a horizontally long image or a vertically long image. FIG. 6(A) is a horizontally long image 28 displayed in the display screen 104, wherein triangular empty spaces 210, 212 are formed above and below the long sides of the horizontally long image 28. Similar triangular empty spaces 214, 216 are also formed to the left and right of the short sides of the horizontally long image 28. A row of image comments 30 is laid out in the empty space 212.

FIG. 6(B) represents a vertically long image 32 displayed in the display screen 104, and in this case, triangular empty spaces 214, 216 are formed to the left and right of the long sides of the vertically long image 32. Similar triangular empty spaces 210, 212 are also formed above and below the short sides of the vertically long image 32. The image comments are separated in FIG. 6(B) and arranged as a date 218 and a title 220 on either side of the vertically long image 32. The empty spaces can thereby be used naturally while maintaining horizontally written image comments.

As described above, although the size relationships may differ, similar triangular empty spaces 210, 212, 214, 216 are formed around the image periphery, whether the image is the horizontally long image 28 of FIG. 6(A) or the vertically long image 32 of FIG. 6(B), and any feeling of strangeness is alleviated during switching between horizontally long images and vertically long images. If the original image is of the same size, whether horizontally long or vertically long, then merely being laid out so that the center of the image is in the center of the display screen 104 removes any need to adjust the size of the image or trim it. In the second example as well, it is desirable to provide an appropriate wallpaper design in the background portion of the empty spaces 210, 212, 214, and 216, whereby the resulting presentation preserves a sense of ordered unity over the entire display screen 104.

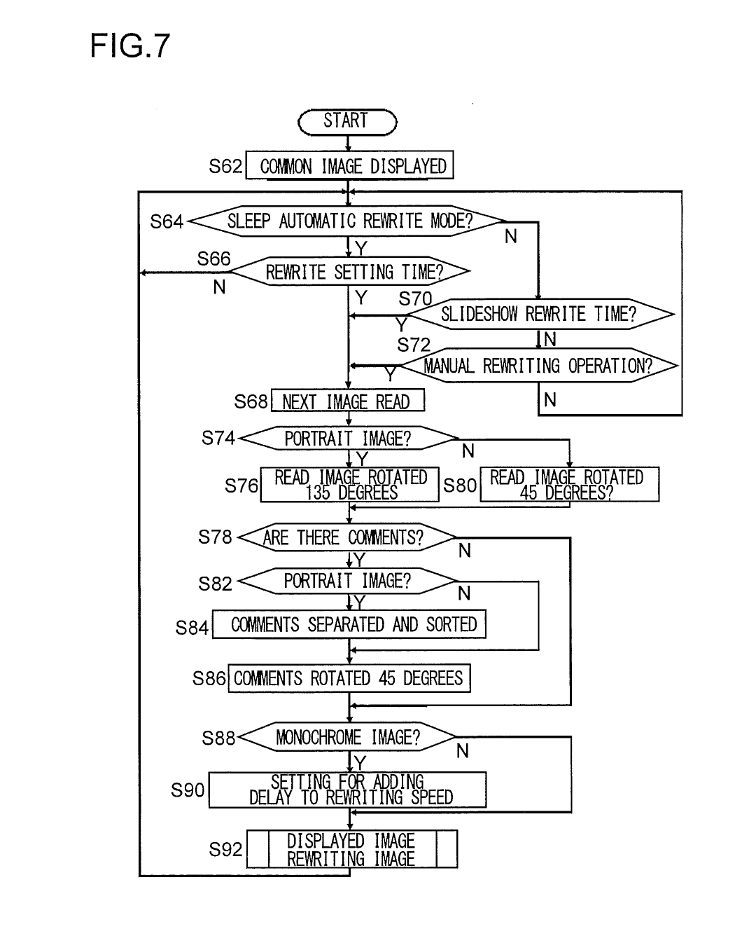

FIG. 7 is a flowchart showing the functions of the controller 8 in the second example of FIG. 5 (the hardware configuration as shown in a block diagram is the same as that of the first example shown in FIG. 1). As in the first example, the flow starts with the battery 5 being installed in the electronic picture frame 102, and the functions continue thereafter as long as power continues to be supplied from the battery 5. When the flow starts, a common image such as wallpaper is initially displayed in step S62 and continues to be displayed thereafter. Next, in step S64, a check is made of whether or not sleep-time automatic rewrite mode has been set. If so, the flow advances to step S66, and a check is made on whether or not the set rewrite time has been reached. If it is detected that the rewrite time has been reached, the flow advances to step S68. If it is not detected in step S66 that the rewrite time has been reached, the flow returns to step S64. Thereafter, steps S64 and S66 are repeated as long as it has been detected in step S64 that the sleep-time automatic rewrite mode has been canceled, or it has not been detected in step S66 that the rewrite time has been reached.

If it is not detected in step S64 that sleep-time automatic rewrite mode is in effect, a slideshow mode is in effect; therefore, the flow advances to step S70, where a check is made of whether or not a slideshow rewrite time has been reached. If so, the flow moves to step S68. If it is not detected in step S70 that the slideshow rewrite time has been reached, the flow advances to step S72 and a check is made of whether or not a manual rewriting operation has been performed. If the operation is detected, the flow moves to step S68. If the operation is not detected, the flow returns to step S64, and as long as a change of mode to the sleep-time automatic rewrite mode is not detected in step S64, steps S64, S70, and S72 are then repeated until the slideshow rewrite time is reached or a manual operation is performed.

In step S68, the next image is read from the storage unit 6 or the storage medium of the storage medium slot 16. A check is then performed in the next step S74 in regard to whether or not the image is a vertically long image, according to the header of the read image data file. If the image is a vertically long image, the flow advances to step S76, a process is performed for rotating the read image 135 degrees, and the flow then moves to step S78. This process is performed to display, horizontally, the short sides of the vertically long image, as in FIG. 6(B). If the image is not detected in step S74 to be a vertically long image, the image is a horizontally long image; therefore, the flow advances to step S80, a process is performed for rotating the read image 45 degrees, and the flow then moves to step S78. This process is performed to display, horizontally, the long sides of the horizontally long image, as in FIG. 6(A).

A check for image comments is then made in step S78. If comments are present, the flow advances to step S82 and a check is made as to whether or not the image is a vertically long image. If the image is a vertically long image, a process is performed in step S84 for separating and arranging the image comments. This process is performed in order to separate the image comments and lay them out to the left and right of the vertically long image as a date 218 and a title 220 as in, e.g., FIG. 6(B). Following the above process, the flow advances to step S86. If the image is not detected in step S82 as being a vertically long image, it is a horizontally long image; therefore, the flow advances directly to step S86. This means that the image comments 30 of the horizontally long image 28 are not separated but are arranged continuously on a single line as in FIG. 6(A) or other drawings.

In step S86, the image comment data that has undergone the process described above is rotated 45 degrees, and the flow moves to step S88. This process is performed regardless of whether the process of dividing and arranging the comments in step S84 has occurred, and is carried out to standardize the image comments in a horizontally written format whether the image is a horizontally long image or a vertically long image as in FIG. 6, and to alleviate any feeling of strangeness between the two. If the presence of image comments is not detected in step S78, the flow moves directly to step S88.

In step S88, a check is made as to whether or not the image is monochrome. If so, a setting is implemented in step S90 to add a delay to the speed of rewriting the displayed image, and the flow then moves to step S92. The setting is made in order to intentionally add a delay to the speed of rewriting the monochrome image and to match the rewriting speed to the rewriting speed of a color image, since it is possible for a monochrome image on electronic paper to be rewritten more quickly than a color image having a greater amount of information. It is thereby possible to prevent any difference in the image rewriting speed of a slideshow containing both color images and monochrome images, and any feeling of strangeness from being experienced. If the image is not detected in step S88 as being a monochrome image, the image is a color image; therefore, the flow moves to step S92.

In step S92, a displayed image rewriting process is performed. This process includes a process of rewriting the electronic paper of the display screen 104 with image data whose layout has been established in steps S68 to S80, the rewriting being performed on the basis of a predetermined action which also addresses the setting information of step S90; and also a process of monitoring whether or not that process has completed. When the image is rewritten and step S92 is complete, the flow returns to step S64, and steps S64 to S92 are thereafter repeated.

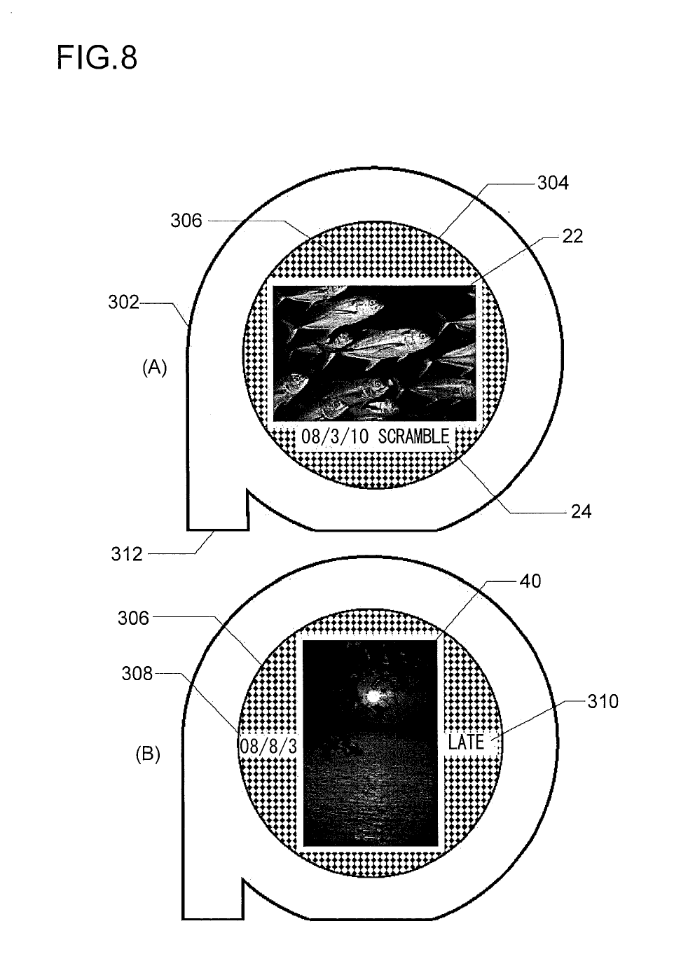

FIG. 8 is an external front view showing a third example of the electronic picture frame according to the embodiment of the present invention. The third example shows another example of an electronic picture frame which is isotropic vertically and horizontally, as with the second example, and which has a display screen in which the edges facing the sides of the photographic image are not parallel to the sides of the photographic image. Specifically, a display screen 304 of an electronic picture frame 302 is circular and isotropic vertically and horizontally. The edges facing the sides of the photographic image are arcuate and not parallel with the sides of the photographic image. As a result, laying out the photographic image in the center of the display screen 304 forms, in the periphery of the short sides, natural empty spaces having shapes resembling those in the periphery of the long sides, and alleviates any feeling of strangeness. As in the first and second examples, regardless of whether it is in a horizontally or vertically long format, the image can be displayed within the display screen 304 merely by being rotated relatively by 90 degrees, without having to be trimmed [or changed] in size.

In FIG. 8(A), a horizontally long image 22 is displayed in the center of the display screen 304, and image comments 24 are displayed thereunder FIG. 8 shows an example of a background wallpaper 306, provided in the empty space of the display screen 304 and presented so as to preserve a sense of ordered unity over the entire display screen 304. In FIG. 8(B), a vertically long image 40 is displayed in the center of the display screen 304, and the image comments are separated into a date 308 and a title 310, as well as being arranged on both the left and right sides of the vertically long image 40.

The electronic picture frame 302 of the third example is configured so that the direction in which it is set up is determined by a bottom surface 312, and the orientation of the display screen 304 cannot be changed vertically or horizontally. Except for the shape of the display screen 304, the third example has the same internal configuration block as that of the first example shown in FIG. 1, and thus the configuration block is neither illustrated nor described. The functions of the controller of the third example are also the same as those of the second example and can be understood according to the flowchart of FIG. 7. In the third example, it is understood that the “135 degrees” indicated in step S76 of FIG. 7 is replaced with “90 degrees,” and steps S80 and S86 are excluded.

A variety of aspects of the present invention can be achieved beyond the scope of the examples described above. For example, even when a photographic image is laid out in the center of the display screen, as in the second or third example, a common image may be always displayed in an empty space not covered by the image, as in the first example, whether a horizontally long image or a vertically long image is displayed. The second and third examples may also be configured such that, as with the first example, the mode in which the image is switched differs between cases of switching between a horizontally long image and a vertically long image and cases of either switching between two horizontally long images or switching between two vertically long images.

In the sleep-time automatic rewrite mode in the examples described above, the rewrite timing detection depends on whether or not the pre-dawn rewrite time has been reached, but this arrangement is not provided by way of limitation to the implementing of the present invention. For example, the configuration in FIG. 1 may be designed such that a brightness detector is provided, wherein, when the brightness detector has detected that the brightness of the room is equal to or less than a predetermined value, it is assumed that the room lighting has been extinguished and the occupants have retired, and rewriting is performed. In this case, it is to be understood that step S6 of FIG. 3 and step S66 of FIG. 7 are both replaced with “darkness of predetermined value or less detected?” Instead of the brightness detector, the electronic picture frame 2 may be configured so as to acquire information about whether a light switch in the room has been turned on or off, from which information it may be detected that the occupants have retired. In this case, it is to be understood that step S6 of FIG. 3 and step S66 of FIG. 7 are both replaced with “is the light switch off?”

The display screens of the examples described above are made from electronic paper with a view towards limiting power consumption and permitting cordless use, but several of various aspects of the present invention are effective even when the present invention is implemented using a liquid crystal display device or another display device. Similarly, the device is not limited to having a battery drive as the power source; a commercial power source may also be used to drive the device.

Hereinbelow is a reaffirmation of the technological aspects disclosed in the present specification.

According to a technological aspect disclosed in the present specification, there is provided an electronic image viewing device having a display screen capable of displaying both a horizontally long image and a vertically long image, and a display controller for displaying either a horizontally long image or a vertically long image on the display screen and always displaying a common image in an empty space not covered by the horizontally long image or the vertically long image when either the horizontally long image or the vertically long image is displayed. Any feeling of strangeness when switching between horizontally long images and vertically long images is thereby alleviated. A suitable example of such a common image is a clock or another time information display.

The technological aspects disclosed in the present specification are particularly effective in cases in which the display screen is held in place so as to be incapable of rotating in the plane thereof; and, when a vertically long image is to be displayed, the controller displays the image rotated 90 degrees in a relative manner, without trimming or changing the size of the image.

According to a specific technological aspect disclosed in the present specification, the display controller performs a control so that a position where one corner of the horizontally long image and that of the vertically long image are displayed matches. The horizontally long images and vertically long images thereby have more portions in common, and any feeling of strangeness experienced during switching between the two is further alleviated. In the embodiment described above, it is preferable that the positions of the corners of the images match on a side diagonally opposite a position where the common image is displayed.

According to another specific technological aspect disclosed in the present specification, the display controller causes an image switching mode to differ between a case in which switching between a horizontally long image and a vertically long image is made, and a case in which switching between two horizontally long images or between two vertically long images is made. This also alleviates any feeling of strangeness during switching between horizontally long images and vertically long images.

According to another specific technological aspect disclosed in the present specification, the display controller also displays the date the image was captured and the title of the image as well as other image comments on the display screen, and divides the display of the image comment when a vertically long image is to be displayed. Any feeling of strangeness related to the presence of empty space can thereby be alleviated.

According to another specific technological aspect disclosed in the present specification, there is provided an electronic image viewing device having a display screen, which is capable of displaying both a horizontally long image and a vertically long image, and which is vertically and horizontally isotropic, wherein an edge of the display screen facing a side of the displayed image is not parallel to the side of the image; and a display controller for causing either a horizontally long image or a vertically long image to be displayed in a center of the display screen. Horizontally long images and vertically long images are thereby easily displayed.

The technological aspects disclosed in the present specification are particularly effective in cases in which the display screen is held in place so as to be incapable of rotating in the plane thereof; and, when a vertically long image is to be displayed, the controller displays the image rotated 90 degrees in a relative manner, without trimming or changing the size of the image.

According to a specific technological aspect disclosed in the present specification, the display controller also displays an image comment on the display screen and divides the display of the image comment when a vertically long image is to be displayed. More specifically, the divided image comments are arranged on both the left and right sides of the vertically long image. It is thereby possible to proactively utilize such a configuration as a design of the empty space.

According to another technological aspect disclosed in the present specification, there is provided an electronic image viewing device having a display screen which has a display device disposed at an incline relative to the horizontal direction, and the display controller causes either a horizontally long image or a vertically long image to be displayed on the display device, wherein the horizontally long image and the vertically long image are rotated at respectively different angles. It is thereby possible to utilize a normal display device to lay out a horizontally long image or a vertically long image without any feeling of strangeness. Specifically, a preferred configuration is one in which the display device is disposed at a 45 degree tilt in relation to the horizontal direction, and the display controller displays either a horizontally long image or a vertically long image at different angles of rotation so that so that a vertical direction of each of the images is upright.

According to another technological aspect disclosed in the present specification, there is provided an electronic image viewing device having a display screen which has electronic paper, a unit for rewriting an image displayed on the display screen, and a display controller for performing a control so that the rewriting performed by the rewriting unit occurs at a timing at which the display screen is not viewed. Such a control can be performed specifically by detecting a timeframe before dawn, or by detecting that the lighting of the room has been made darker. Thus, by having the image rewritten at a timing at which the display screen is not viewed, it is possible to use electronic paper having a slow rewriting speed.

According to another technological aspect disclosed in the present specification, there is provided an electronic image viewing device having a display screen which has electronic paper, a detector for detecting whether the image displayed on the display screen is in color or monochrome, and a display controller for performing a control, when the detector has detected that the image is monochrome, so that a speed at which the image is rewritten is caused to match a speed at which a color image is rewritten. It is thereby possible to reduce any feeling of strangeness in rewriting when monochrome images and color images are combined.

### INDUSTRIAL APPLICABILITY

The present invention is suitably applicable for electronic picture frames and the like for viewing digital images.

### LIST OF REFERENCE SIGNS

4, 104, 304 Display screen
22, 28 Horizontally long image
32, 40 Vertically long image
26 Common image
8 Display controller
104 Display device disposed at a tilt
4, 104, 304 Electronic paper
8, 18 Detector
10 Rewriting unit

1. An electronic image viewing device comprising a display screen capable of displaying both a horizontally long image and a vertically long image, and a display controller for displaying either a horizontally long image or a vertically long image on the display screen and always displaying a common image in an empty space not covered by the horizontally long image or the vertically long image when either the horizontally long image or the vertically long image is displayed.

2. The electronic image viewing device according to claim 1, wherein the display screen is held in place so as to be incapable of rotating in the plane thereof; and, when a vertically long image is to be displayed, the controller displays the image rotated 90 degrees in a relative manner, without trimming or changing the size of the image.

3. The electronic image viewing device according to claim 1, wherein the display controller performs a control so that a position where one corner of the horizontally long image and that of the vertically long image are displayed matches.

4. The electronic image viewing device according to claim 3, wherein the display controller causes the positions of the corners of the images to match on a side diagonally opposite a position where the common image is displayed.

5. The electronic image viewing device according to claim 1, wherein the display controller causes an image switching mode to differ between a case in which switching between a horizontally long image and a vertically long image is made, and a case in which switching between two horizontally long images or between two vertically long images is made.

6. The electronic image viewing device according to claim 1, wherein the common image is time information.

7. The electronic image viewing device according to claim 1, wherein the display controller also displays an image comment on the display screen and divides the display of the image comment when a vertically long image is to be displayed.

8. An electronic image viewing device comprising a display screen, which is capable of displaying both a horizontally long image and a vertically long image, and which is vertically and horizontally isotropic, wherein an edge of the display screen facing a side of the displayed image is not parallel to the side of the image; and a display controller for causing either a horizontally long image or a vertically long image to be displayed in a center of the display screen.

9. The electronic image viewing device according to claim 8, wherein the display screen is held in place so as to be incapable of rotating in the plane thereof; and, when a vertically long image is to be displayed, the controller displays the image rotated 90 degrees in a relative manner, without trimming or changing the size of the image.

10. The electronic image viewing device according to claim 8, wherein the display controller also displays an image comment on the display screen and divides the display of the image comment when a vertically long image is to be displayed.

11. The electronic image viewing device according to claim 10, wherein the display controller displays the divided image comments so that the comments are arranged on both the left and right sides of the vertically long image.

12. The electronic image viewing device according to claim 8, wherein the display screen is substantially square-shaped and is tilted at a 45 degree angle in relation to the horizontal direction.

13. The electronic image viewing device according to claim 8, wherein the display screen has a display device disposed at an incline relative to the horizontal direction, and the display controller causes either a horizontally long image or a vertically long image to be displayed on the display device, wherein the horizontally long image and the vertically long image are rotated at respectively different angles.

14. The electronic image viewing device according to claim 13, wherein the display device is disposed at a 45 degree tilt in relation to the horizontal direction, and the display controller displays either a horizontally long image or a vertically long image at different angles of rotation so that a vertical direction of each of the images is upright.

15. The electronic image viewing device according to claim 8, the display screen has electronic paper, and the electronic image viewing device comprises a unit for rewriting an image displayed on the display screen, and a display controller for controlling the rewriting performed by the rewriting unit on the basis of a predetermined condition.

16. An electronic image viewing device comprising a display screen having electronic paper, a unit for rewriting an image displayed on the display screen, and a display controller for controlling the rewriting performed by the rewriting unit on the basis of a predetermined condition.

17. The electronic image viewing device according to claim 16, wherein the display controller detects a timing at which the display screen is not viewed, and performs rewriting using the detected timing as a condition.

18. The electronic image viewing device according to claim 17, wherein the display controller detects a timeframe before dawn.

19. The electronic image viewing device according to claim 16 comprising a detector for detecting whether the image displayed on the display screen is in color or monochrome, wherein the display controller performs rewriting using a detection result of the detector as a condition.

20. The electronic image viewing device according to claim 19, wherein when the detector has detected that the image is in monochrome, the display controller performs a control so that a speed at which the image is rewritten is caused to match a speed at which a color image is rewritten.
